(19) United States
(12) Patent Application Publication
(10) Pub. No.: US 2022/0057796 A1
(43) Pub. Date: Feb. 24, 2022

(54) DEVICE AND METHOD FOR CONTROLLING AUTONOMOUS DRIVING

(71) Applicants: HYUNDAI MOTOR COMPANY, Seoul (KR); KIA MOTORS CORPORATION, Seoul (KR)

(72) Inventors: Dong Il YANG, Seoul (KR); Eun Young CHOI, Seoul (KR); Ki Seok SEONG, Chungcheongnam-do (KR); Min Sang YU, Hwaseong-si (KR); Hyeong Jin HAM, Seongnam-si (KR); Rosali Sun PYUN, Seongnam-si (KR); Jin Su JEONG, Suwon-si (KR); Woo Jin KIM, Incheon (KR)

(21) Appl. No.: 17/213,799

(22) Filed: Mar. 26, 2021

(30) Foreign Application Priority Data
Aug. 24, 2020 (KR) 10-2020-0106435

(51) Int. Cl. G05D 1/00; G05D 1/02; B60W 60/00; B60W 50/14

(52) U.S. Cl. CPC G05D 1/0061; G05D 1/0276; B60W 50/14; B60W 60/005; B60W 60/0027

(57) ABSTRACT

A device for controlling autonomous driving of a vehicle includes: a communication device that supports communication with a data storage system for automated driving (DSSAD); a detector that detects travel environment information of the vehicle; and a processor that predicts a possible event by utilizing at least one of event data recorded in the DSSAD or the travel environment information, and performs an operation support service for the possible event.

### CROSS-REFERENCE TO RELATED APPLICATION

This application claims the benefit of priority to Korean Patent Application No. 10-2020-0106435, filed in the Korean Intellectual Property Office on Aug. 24, 2020, the entire contents of which are incorporated herein by reference.

### TECHNICAL FIELD

The present disclosure relates to a device and a method for controlling autonomous driving.

### BACKGROUND

An autonomous vehicle refers to a vehicle that determines a risk by recognizing a travel environment and plans a travel route without manipulation of a driver, thereby traveling by itself. Levels of automation of such autonomous vehicle can be classified into six levels from a level 0 to a level 5 based on a guideline (J3016) proposed by the Society of Automotive Engineers (SAE).

To determine a subject of a driving right, in other words, a control right, when various events such as turning on or off of an autonomous driving function, a transition demand (TD), and/or Minimum Risk maneuver (MRM) in an autonomous vehicle of a level equal to or higher than 3, mandatory installation of a data storage system for automated driving (DSSAD) that may record information on times of events for about 6 months and of the number of 2500 is being promoted. The autonomous vehicle basically recognizes and responds to various events on a road using information sensed in real time, communication data, and map information, but utilization of data accumulated in the data storage system for automated driving is insufficient.

The information included in this Background section is only for enhancement of understanding of the general background of the present disclosure and may not be taken as an acknowledgement or any form of suggestion that this information forms the prior art already known to a person skilled in the art.

### SUMMARY

The present disclosure has been made to solve the above-mentioned problems occurring in the prior art while advantages achieved by the prior art are maintained intact.

An aspect of the present disclosure provides a device and a method for controlling autonomous driving that support an operation of an autonomous vehicle by utilizing information recorded in a data storage system for automated driving.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for controlling autonomous driving of a vehicle includes: a communication device that supports communication with a data storage system for automated driving (DSSAD); a detector that detects travel environment information of the vehicle; and a processor that predicts a possible event by utilizing at least one of event data recorded in the DSSAD or the travel environment information, and performs an operation support service for the possible event.

The event data may include information on an occurrence time and an occurrence position information of a predefined event.

The predefined event may include an autonomous driving function activation event, an autonomous driving function deactivation event, and a control right transition demand event.

The processor may recognize an autonomous driving function activation frequent section or an autonomous driving function deactivation frequent section by utilizing accumulated data on the autonomous driving function activation event and the autonomous driving function deactivation event.

The processor may output an advance notification by sensing whether the vehicle has entered the autonomous driving function activation frequent section or the autonomous driving function deactivation frequent section based on position information of the vehicle.

The processor may register the autonomous driving function activation frequent section or the autonomous driving function deactivation frequent section as user-customized information based on a user response to the advance notification.

The processor may delete the user-customized information when a non-use period of the user-customized information is a threshold period or more.

The processor may predict a control right transition demand occurrence point by analyzing occurrence history information of the control right transition demand event and the travel environment information.

The processor may activate a control right transition ready mode and output an advance notification when the vehicle approaches the control right transition demand occurrence point.

The processor may perform control right transition in response to a user response to the advance notification.

According to another aspect of the present disclosure, a method for controlling autonomous driving of a vehicle includes: initiating, by the vehicle, the autonomous driving; detecting travel environment information of the vehicle; predicting a possible event by utilizing at least one of event data recorded in a data storage system for automated driving (DSSAD) of the vehicle or the travel environment information; and performing an operation support service for the possible event.

The event data may include information on an occurrence time and an occurrence position information of a predefined event.

The predefined event may include an autonomous driving function activation event, an autonomous driving function deactivation event, and a control right transition demand event.

The predicting of the possible event may include recognizing an autonomous driving function activation frequent section or an autonomous driving function deactivation frequent section by utilizing accumulated data on the autonomous driving function activation event and the autonomous driving function deactivation event, and sensing whether the vehicle has entered the autonomous driving function activation frequent section or the autonomous driving function deactivation frequent section based on position information of the vehicle.

The performing of the operation support service may include outputting an advance notification for the entry of the autonomous driving function activation frequent section or the autonomous driving function deactivation frequent section.

The performing of the operation support service may further include registering the autonomous driving function activation frequent section or the autonomous driving function deactivation frequent section as user-customized information based on a user response to the advance notification.

The performing of the operation support service may further include deleting the user-customized information when a non-use period of the user-customized information is a threshold period or more.

The predicting of the possible event may include predicting a control right transition demand occurrence point by analyzing occurrence history information of the control right transition demand event and the travel environment information.

The performing of the operation support service may include activating a control right transition ready mode and outputting an advance notification when the vehicle approaches the control right transition demand occurrence point.

The performing of the operation support service may further include performing control right transition in response to a user response to the advance notification.

### BRIEF DESCRIPTION OF THE DRAWINGS

The above and other objects, features and advantages of the present disclosure will be more apparent from the following detailed description taken in conjunction with the accompanying drawings.

FIG. 1 illustrates a block diagram of a device for controlling autonomous driving according to embodiments of the present disclosure;

FIG. 2 is a flowchart illustrating a method for controlling autonomous driving according to embodiments of the present disclosure;

FIG. 3 is a flowchart illustrating a method for providing a service for supporting an operation of an autonomous vehicle according to an embodiment of the present disclosure;

FIG. 4 is a flowchart illustrating a method for providing a service for supporting an operation of an autonomous vehicle according to another embodiment of the present disclosure;

FIG. 5 is an exemplary view for illustrating a method for providing an advance notification according to another embodiment of the present disclosure; and

FIG. 6 is a block diagram illustrating a computing system for executing a method for controlling autonomous driving according to embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

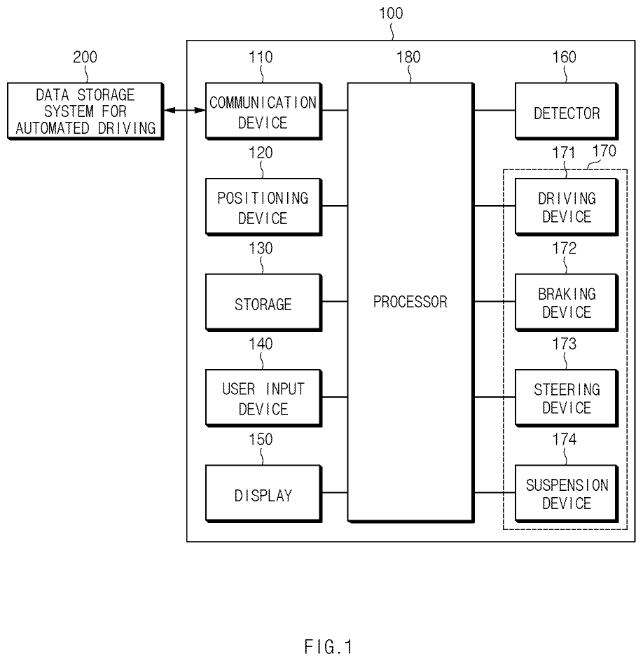

FIG. 1 illustrates a block diagram of a device for controlling autonomous driving according to embodiments of the present disclosure.

An autonomous driving control device 100 may be mounted together with a data storage system for automated driving (DSSAD) 200 in a vehicle capable of autonomous driving (e.g., an autonomous vehicle of a level equal to or higher than 3). Referring to FIG. 1, the autonomous driving control device 100 may include a communication device 110, a positioning device 120, storage 130, a user input device 140, a display 150, a detector 160, a vehicle controller 170, and a processor 180.

The communication device 110 may support performing communication with an external device and/or the data storage system for automated driving 200. The external device may be a server that provides information collected through another vehicle and/or a database device that provides road information (e.g., road construction and the like). When a predefined event occurs, the data storage system for automated driving 200 may record (store) event data including information on an occurrence time and information on an occurrence position of the corresponding event. The predefined event may include an autonomous driving function activation event, an autonomous driving function deactivation event, a control right transition demand (TD) event in an unplanned event and/or a Minimum Risk Manoeuver (MRM) start event. Although not shown in the drawing, the data storage system for automated driving 200 may include a communication circuit that supports the communication with the autonomous driving control device 100, a memory that stores instructions executed by a processor, the processor, and the like.

The communication device 110 may include a communication processor, a communication circuit, an antenna, and/or a transceiver. The communication device 110 may use communication technologies such as in-vehicle communication (in-vehicle network, IVN), wireless Internet, short-range communication, and/or mobile communication. As the in-vehicle communication technology, controller area network (CAN), media oriented systems transport (MOST) network, local interconnect network (LIN), ethernet, and/or X-by-Wire (Flexray) may be applied. As the wireless Internet technology, wireless LAN (WLAN) (Wi-Fi), wireless broadband (Wibro), and the like may be used. As the short-range communication technology, Bluetooth, near field communication (NFC), radio frequency identification (RFID), ZigBee, and the like may be used. As the mobile communication technology, code division multiple access (CDMA), global system for mobile Communication (GSM), long term evolution (LTE), international mobile telecommunication (IMT)-2020, and the like may be used.

The positioning device 120 may measure a current position of the vehicle. The positioning device 120 may measure the vehicle position using at least one of positioning technologies, such as a global positioning system (GPS), a dead reckoning (DR), a differential GPS (DGPS), a carrier phase differential GPS (CDGPS), and the like. When using the GPS, the positioning device 120 may calculate the current position of the vehicle (the vehicle position) using triangulation.

The storage 130 may store map information (map database). The storage 130 may store logic that performs a predetermined function, such as an autonomous driving control logic, a travel event determination logic, and/or a warning output time determination logic. The storage 130 may temporarily store input data and/or output data resulted from an operation of the processor 180 and may store various setting information. The storage 130 may be implemented as a non-transitory storage medium that stores instructions executed by the processor 180. The storage 130 may be implemented as at least one of storage media (recording media), such as a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, web storage, or the like.

The user input device 140 may generate data resulted from manipulation of a user. The user input device 140 may generate data that turns on or off an autonomous driving function in response to a user input. The user input device 140 may include a button, a switch, a touch pad, and/or a touch screen. The user input device 140 is placed on a steering wheel, a dashboard, a center fascia, and/or a door trim. The user input device 140 may include a steering wheel, an accelerator pedal, and/or a braking pedal.

The display 150 may output visual information under control of the processor 180. The display 150 may include at least one of a liquid crystal display (LCD), a thin film transistor-liquid crystal display (TFT-LCD), an organic light-emitting diode (OLED) display, a flexible display, a three-dimensional display (3D display), a transparent display, a head-up display (HUD), an augmented reality (AR) HUD, a touchscreen, or a cluster. The display 150 may include an audio output module such as a speaker capable of outputting audio data (e.g., a warning sound and the like) and/or a tactile signal output module capable of outputting a tactile signal (e.g., vibration and the like).

The detector 160 may detect travel environment information using sensors mounted on the vehicle. The sensors may include a steering angle sensor, an accelerator pedal position sensor, a braking pedal position sensor, an image sensor (a camera), a microphone, a wheel speed sensor, a 3-axis accelerometer, an inertial measurement unit (IMU), and/or an advanced driver assistance system (ADAS) sensor. The ADAS sensor may include a light detection and ranging (LiDAR), a radio detecting and ranging (RADAR), a camera, and/or ultrasound.

The vehicle controller 170 controls steering, braking, suspension, and/or driving of the vehicle, which may include a driving device 171, a braking device 172, a steering device 173, a suspension device 174, and the like. In the present disclosure, the vehicle controller 170 may include a computer or processor such as a CPU or an electronic control unit (ECU) configured to be programmed to control various electronic devices. The driving device 171, the braking device 172, and the steering device 173 may each include a control unit or may be embedded in the vehicle controller 170 as one control unit.

The driving device 171 controls the driving of the vehicle, which may transmit power generated from a power source (e.g., an engine or a motor) to a wheel. The driving device 171 may be implemented as a traction control system (TCS) and/or an all-wheel drive (AWD) system.

The braking device 172 may decelerate or stop the vehicle. The braking device 172 may include an anti-lock braking system (ABS), an electronic stability control (ESC), and/or an electronic parking brake (EPB) system.

The steering device 173 may change a traveling direction of the traveling vehicle. The steering device 173 may be implemented as a four-wheel steering system (4WS), an electric power steering (EPS), an active front steering (AFS), and/or a steer by wire (SBW).

The suspension device 174 may reduce a vibration and a shock generated on a road surface by connecting a vehicle body with an axle and maintain a posture of the vehicle. The suspension device 174 may be composed of a spring for mitigating the shock transmitted from the road surface, a damper for suppressing a free vibration, and a stabilizer bar for suppressing a roll motion to improve travel stability of the vehicle. In addition, the suspension device 174 may actively change a height of the vehicle body as well as a damping force of the damper and a stiffness of the stabilizer bar based on the travel environment.

The processor 180 may control overall operations of the autonomous driving control device 100. The processor 180 may include at least one of an application specific integrated circuit (ASIC), a digital signal processor (DSP), a programmable logic device (PLD), a field programmable gate array (FPGA), a central processing unit (CPU), a microcontroller, or a microprocessor.

The processor 180 may activate the autonomous driving function in response to the user input. For example, when data representing the autonomous driving function ON (activation) is received from the user input device 140, the processor 180 may execute the autonomous driving function. The processor 180 may also execute the autonomous driving function when a destination is set. When the autonomous driving function is activated, the processor 180 may control the vehicle controller 170 to execute autonomous driving.

The processor 180 may sense (recognize) the occurrence of the predefined event during the autonomous driving. The processor 180 may transmit the event data including the information on the occurrence time and the information on the occurrence position of the detected event to the data storage system for automated driving 200. The data storage system for automated driving 200 may accumulate and store the event data provided from the processor 180. The data storage system for automated driving 200 may store the event data for a preset period or may store a preset number of event data. The data storage system for automated driving 200 may delete the event data starting from event data having the longest storage period when a space capable of storing the event data becomes smaller than a threshold.

The processor 180 may collect the travel environment information through the detector 160 when the vehicle initiates the autonomous driving. The travel environment information may collect a speed of another vehicle (e.g., a surrounding vehicle and/or a preceding vehicle), a distance between the vehicle and another vehicle, an image of a surrounding region, weather information (e.g., rainfall), and/or sound information. For example, the processor 180 may analyze the image of the surrounding region obtained through the camera to recognize notification information (e.g., ‘The third lane 1 km ahead is under construction’) of an electric sign installed on a roadside. In addition, the processor 180 may obtain the sound information such as an emergency vehicle siren using the microphone. The processor 180 may obtain the weather information through communication with the external device (e.g., a weather center server). In addition, the processor 180 may receive another vehicle information (i.e., information collected by another vehicle) and/or the road information from an external device.

The processor 180 may predict (estimate) a possible event using data obtained from the vehicle, for example, the event data recorded in the data storage system for automated driving 200 and/or the travel environment information. The processor 180 may output an advance notification to notify the user (e.g., a driver) of the predicted possible event in advance. The advance notification may be output in at least one of information forms, such as the visual information, the auditory information, the tactile information, or the like.

The processor 180 may determine true or false of the advance notification information by recording a travel result for the advance notification. The processor 180 may use the determination result as feedback data. The processor 180 may utilize the feedback data by recording whether the possible event notified through the advance notification has occurred in actual travel. The processor 180 may convert the possible event from a planned event to the unplanned event or from the unplanned event to the planned event based on the feedback data.

The processor 180 may predict the possible event by analyzing the event data recorded in the data storage system for automated driving 200 and/or the travel environment information, and may provide an operation support service based on the predicted possible event.

The processor 180 may recommend ON or OFF of a user-customized autonomous driving function by utilizing autonomous driving function operation information stored in the data storage system for automated driving 200. The autonomous driving function operation information may include autonomous driving function activation event data and/or autonomous driving function deactivation event data. The processor 180 may recognize an autonomous driving function activation frequent section or an autonomous driving function deactivation frequent section by analyzing the autonomous driving function operation information. The processor 180 may determine whether the vehicle enters the autonomous driving function activation/deactivation frequent section by comparing vehicle position information obtained through the positioning device 120 with recognized autonomous driving function activation/deactivation frequent section information.

The processor 180 may output the advance notification (recommendation) notifying the entry of the vehicle to the autonomous driving function activation/deactivation frequent section when the vehicle enters the autonomous driving function activation/deactivation frequent section. For example, when the vehicle enters the autonomous driving function activation frequent section, the processor 180 may output a message such as “This is a section where the autonomous driving function is frequently activated. Would you activate the autonomous driving function?” on the display. Further, when the vehicle enters the autonomous driving function deactivation frequent section, the processor 180 may display a message such as “This is a section where control right transition occurs frequently. Would you like to deactivate a control right in advance?” on the display.

The processor 180 may register the autonomous driving function activation/deactivation frequent section as user-customized information based on a user response to the advance notification. For example, when the user response to the advance notification notifying the entry of the autonomous driving function activation frequent section is execution of the autonomous driving function ON equal to or more than the predetermined number of times, the processor 180 may register the autonomous driving function ON when entering the corresponding autonomous driving function activation frequent section as the user-customized information. In this connection, the processor 180 may register the autonomous driving function ON when entering the corresponding autonomous driving function activation frequent section depending on whether the user has approved or automatically. The processor 180 may output a message such as “This is a section where activation recommendation has been approved 3 times or more. Would you like to register this section to your favorites?”, and then may register the section as the user-customized information when there is user approval. In addition, when there is the same user response equal to or more than a predetermined number of times, the processor 180 may automatically register the autonomous driving function activation/deactivation frequent section and the user response as the user-customized information, and then output a message such as “This is a section where the activation recommendation has been approved 10 times or more. Would you like to register this section to your favorites?”.

The processor 180 may periodically manage and update the user-customized information. When the user-customized information is not used for a predetermined threshold period or more, the processor 180 may delete the corresponding user-customized information or output an edit recommendation notification. For example, when specific user-customized information has not been used for one month or more, the processor 180 may output a notification such as “There was no corresponding section travel for one month. Would you like to delete this section from a custom menu?”, and delete the user-customized information based on user approval information. In addition, after deleting user-customized information unused for a certain period of time, the processor 180 may output a notification such as “There was no corresponding section travel for 6 months. I will delete this section from the custom menu.”

The processor 180 may predict an occurrence of the TD in the unplanned event in advance by utilizing TD event data accumulated and stored in the data storage system for automated driving 200. When the occurrence of the TD is predicted, the processor 180 may activate a control right transition ready (TD ready) mode. In addition, when the occurrence of the TD is predicted, the processor 180 may provide the advance notification (warning) before the occurrence of the TD.

The processor 180 may predict an occurrence of an unexpected event in advance based on the predefined definition of the planned event and the unplanned event and a warning time, and output the advance notification and/or the warning therefor. The planned event refers to an expected event known in advance in which a control right transition is demanded, for example, an event in which a driving right transition is demanded based on the map information, such as a highway exit entrance ramp, and the advance notification and/or the warning is required before a predetermined time (e.g., 15 seconds) before the corresponding event occurs. The unplanned event refers to an event that is not determined in advance, but a likelihood of an occurrence is expected to be equal to or higher than a threshold value, so that the control right transition demand is requested. As soon as the event occurs, the advance notification and/or the warning is required. For example, the unplanned event may be an event not defined as the event expected in advance, such as a construction section on the road, a bad weather condition, emergency vehicle approach, an event in which a line is not indicated, an event in which an object is dropped from a truck, an event in which the road is blocked by a crash accident, or the like.

The processor 180 may determine whether there is a history of the TD occurrence in the unplanned event on the position information of the vehicle. The processor 180 may additionally collect (obtain) sensing information, that is, the travel environment information, through the detector 160. The processor 180 may provide the advance notification (and/or the advance warning) by combining the TD occurrence history information and the sensing information with each other. For example, when entry of a vague line section is expected by utilizing the TD generation history and the sensing information on the travel route of the vehicle, the processor 180 may activate the TD ready mode before entering the corresponding section and output the advance warning. The processor 180 may recognize the emergency vehicle approach through the microphone in an event in which sensing and/or determination is not possible as a rear camera is covered by a following vehicle (e.g., the truck and the like), activate the TD ready mode, and then, output the advance warning (the advance notification).

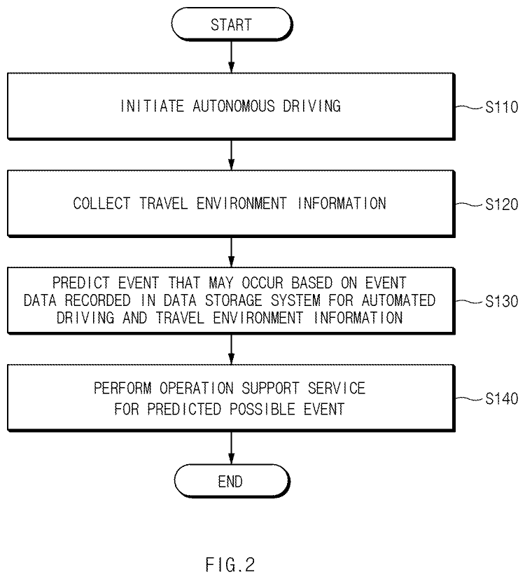

FIG. 2 is a flowchart illustrating a method for controlling autonomous driving according to embodiments of the present disclosure.

The processor 180 may initiate the autonomous driving (S110). The processor 180 may activate the autonomous driving function when a signal indicating the autonomous driving function ON is received from the user input device 140. In addition, the processor 180 may activate the autonomous driving function when receiving a signal informing that determination of the travel route to the destination is completed from a navigation terminal. In addition, the processor 180 may initiate the autonomous driving through determination by itself.

The processor 180 may collect the travel environment information through the detector 160 during the autonomous driving (S120). The travel environment information may include the weather information, the road information, and/or surrounding vehicle information. The detector 160 may obtain the weather information through a rain sensor, a temperature sensor, a humidity sensor, and/or an illuminance sensor. The detector 160 may detect the information displayed on the electric sign installed on the roadside using the image sensor (the camera). The detector 160 may sense the sound information using the microphone. In addition, the processor 180 may identify the vehicle position in real time using the positioning device 120 while performing the autonomous driving.

The processor 180 may predict an event that may occur in front of the vehicle based on the event data recorded in the data storage system for automated driving 200 and the travel environment information (S130). The event data including the information on the occurrence time and the information on the occurrence position of the events such as the autonomous driving function activation event, the autonomous driving function deactivation event, the control right transition demand event in the unplanned event, and/or the minimum risk maneuver start event may be accumulated and stored in the data storage system for automated driving 200. The processor 180 may estimate the possible event by combining the event data accumulated in the data storage system for automated driving 200 and the travel environment information collected using the detector 160 with each other.

The processor 180 may perform the operation support service for the predicted possible event (S140). The processor 180 may output the advance notification and/or the advance warning for the possible event before the vehicle reaches a point at which the occurrence of the event is predicted.

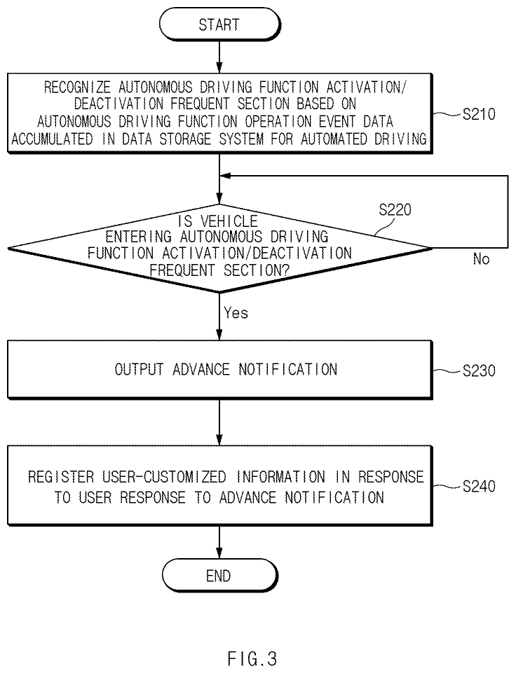

FIG. 3 is a flowchart illustrating a method for providing a service for supporting an operation of an autonomous vehicle according to an embodiment of the present disclosure.

The processor 180 may recognize the autonomous driving function activation or deactivation frequent section based on autonomous driving function operation event data accumulated in the data storage system for automated driving 200 during the autonomous driving (S210). The autonomous driving function operation event data may include the information on the occurrence time and the information on the occurrence position of the autonomous driving function activation event and the autonomous driving function deactivation event. The processor 180 may recognize the autonomous driving function activation frequent section or the autonomous driving function deactivation frequent section by analyzing the accumulated autonomous driving function operation event data.

The processor 180 may determine whether the vehicle is entering the autonomous driving function activation frequent section or the autonomous driving function deactivation frequent section (S220). The processor 180 may compare the vehicle position information obtained through the positioning device 120 with the recognized autonomous driving function activation/deactivation frequent section information to determine whether the vehicle is entering the autonomous driving function activation/deactivation frequent section.

When it is determined that the vehicle is entering the autonomous driving function activation/deactivation frequent section, the processor 180 may output the advance notification (the recommendation) informing the same (S230). For example, when the vehicle enters the autonomous driving function activation frequent section, the processor 180 may output the message such as “This is the section where the autonomous driving function is frequently activated. Would you activate the autonomous driving function?” on the display. In addition, when the vehicle enters the autonomous driving function deactivation frequent section, the processor 180 may display the message such as “This is a section where the autonomous driving function is frequently deactivated. Would you deactivate the autonomous driving function in advance?” on the display.

The processor 180 may register the autonomous driving function activation/deactivation frequent section as the user-customized information in response to the user response to the advance notification (S240). For example, when the user response to the advance notification notifying the entry of the autonomous driving function activation frequent section is the execution of the autonomous driving function ON equal to or more than the predetermined number of times, the processor 180 may register the autonomous driving function ON when entering the corresponding autonomous driving function activation frequent section as the user-customized information. In this connection, the processor 180 may register the autonomous driving function ON when entering the corresponding autonomous driving function activation frequent section depending on whether the user has approved or automatically. The processor 180 may output the message such as “This is the section where the activation recommendation has been approved 3 times or more. Would you like to register this section to your favorites?”, and then may register the section as the user-customized information when there is the user approval. In addition, when there is the same user response equal to or more than the predetermined number of times, the processor 180 may automatically register the autonomous driving function activation/deactivation frequent section and the user response as the user-customized information, and then output the message such as “This is the section where the activation recommendation has been approved 10 times or more. Would you like to register this section to your favorites?”.

Thereafter, the processor 180 may periodically manage and update the user-customized information. When the user-customized information is not used for the predetermined period or more, the processor 180 may delete the corresponding user-customized information or output the edit recommendation notification. For example, when the specific user-customized information has not been used for one month or more, the processor 180 may output the notification such as “There was no corresponding section travel for one month. Would you like to delete this section from the user custom menu?”, and delete the corresponding user-customized information based on the user approval information. In addition, after deleting the user-customized information unused for the certain period of time, the processor 180 may output the notification such as “There was no corresponding section travel for 6 months. I will delete this section from the user custom menu.”

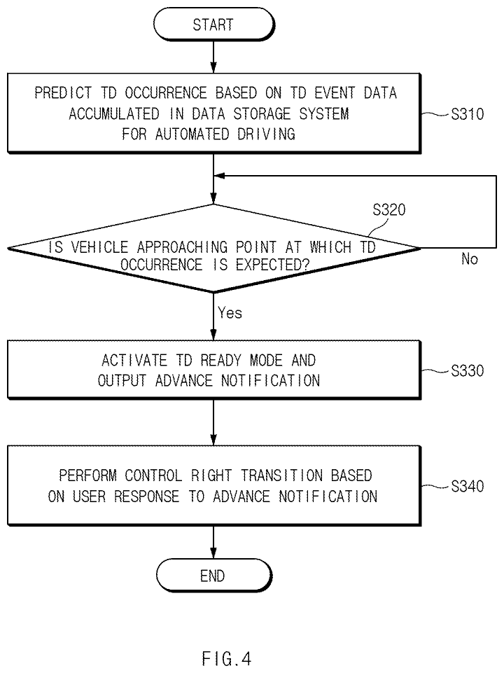

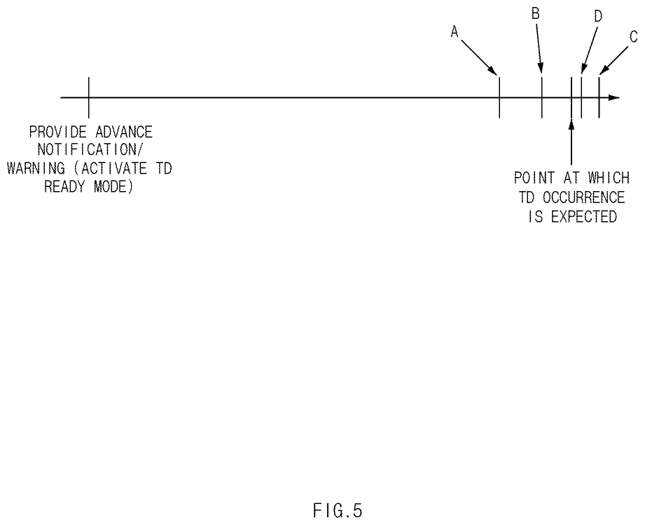

FIG. 4 is a flowchart illustrating a method for providing a service for supporting an operation of an autonomous vehicle according to another embodiment of the present disclosure, and FIG. 5 is an exemplary view for illustrating a method for providing an advance notification according to another embodiment of the present disclosure.

The processor 180 may predict the TD occurrence in the unplanned event in advance by utilizing the TD event data accumulated and stored in the data storage system for automated driving 200 (S310). The processor 180 may calculate a point at which the TD occurrence is expected on the travel route to be traveled by the vehicle based on the TD event occurrence history stored in the data storage system for automated driving 200. The processor 180 may additionally collect (obtain) the sensing information, that is, the travel environment information, through the detector 160. The processor 180 may calculate the point at which the TD occurrence is expected by combining the TD event occurrence history information (the TD occurrence history) and the sensing information with each other.

The processor 180 may determine whether the vehicle is approaching the point at which the TD occurrence is expected (S320). The processor 180 may determine that the vehicle is approaching the point at which the TD occurrence is expected when there is a predetermined time left until the vehicle reaches the point at which the TD occurrence is expected or when the vehicle is positioned within a predetermined distance from the point at which the TD occurrence is expected.

When the vehicle is approaching the point at which the TD occurrence is expected, the processor 180 may activate the TD ready mode (the control right transition ready mode) and output the advance notification (S330). The processor 180 may output a message such as “The TD is expected to occur 1 km ahead. Would you transit the control right in advance?” on the display. The processor 180 may also output the warning sound through the speaker when outputting the message.

The processor 180 may perform the control right transition based on the user response to the advance notification (S340). The processor 180 may transit the control right to the user when a command indicating control right transition approval is input by the user after outputting the advance notification.

Referring to FIG. 5, when there is the past TD occurrence history at points A, B, and C, and information indicating that a point D is under construction is displayed on the electric sign, the processor 180 may calculate the point at which the TD occurrence is expected by utilizing the TD occurrence history information and the electric sign information obtained through the camera. The processor 180 may activate the TD ready mode the certain time (or the certain distance) before the vehicle arrives at the point at which the TD occurrence is expected and may output the advance notification.

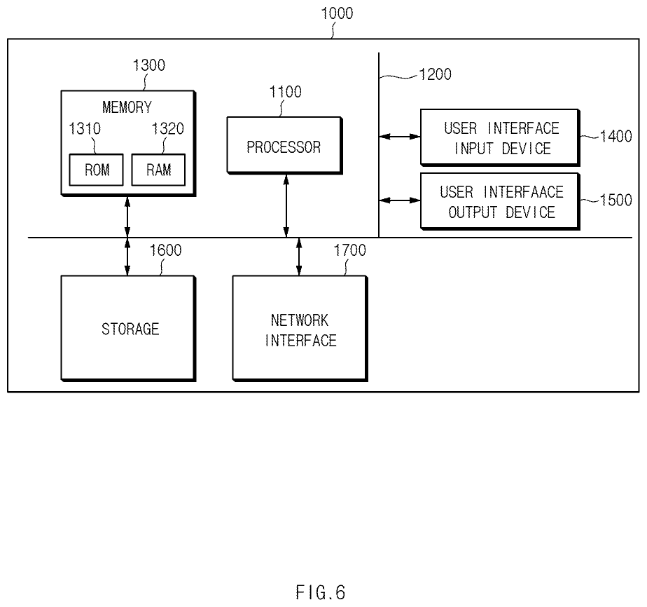

FIG. 6 is a block diagram illustrating a computing system for executing a method for controlling autonomous driving according to embodiments of the present disclosure.

With reference to FIG. 6, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor 1100 and the storage medium may reside within an application specific integrated circuit (ASIC). The ASIC may reside within the user terminal. In another method, the processor 1100 and the storage medium may reside as individual components in the user terminal.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, because the operation of the autonomous vehicle may be supported by utilizing the information recorded in the data storage system for automated driving, the operation support service may be supported without an increase in cost and safety and convenience of the driver may be improved.

Further, according to the present disclosure, the service with improved reliability may be provided by utilizing the accumulated information stored in the data storage system for automated driving and the information sensed by the sensing devices mounted on the vehicle.

Further, according to the present disclosure, when an autonomous vehicle of a level 4 activates the MRM as an emergency event occurs, the advance warning enables the driver to recognize and respond to the emergency event early.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling autonomous driving of a vehicle, the device comprising:
a communication device configured to support communication with a data storage system for automated driving (DSSAD);
a detector configured to detect travel environment information of the vehicle; and
a processor configured to:
predict a possible event by utilizing at least one of event data recorded in the DSSAD or the travel environment information; and
perform an operation support service for the possible event.

2. The device of claim 1, wherein the event data includes information on an occurrence time and occurrence position information of a predefined event.

3. The device of claim 2, wherein the predefined event includes an autonomous driving function activation event, an autonomous driving function deactivation event, and a control right transition demand event.

4. The device of claim 3, wherein the processor is configured to recognize an autonomous driving function activation frequent section or an autonomous driving function deactivation frequent section by utilizing accumulated data on the autonomous driving function activation event and the autonomous driving function deactivation event.

5. The device of claim 4, wherein the processor is configured to output an advance notification by sensing whether the vehicle has entered the autonomous driving function activation frequent section or the autonomous driving function deactivation frequent section based on position information of the vehicle.

6. The device of claim 5, wherein the processor is configured to register the autonomous driving function activation frequent section or the autonomous driving function deactivation frequent section as user-customized information based on a user response to the advance notification.

7. The device of claim 6, wherein the processor is configured to delete the user-customized information when a non-use period of the user-customized information is a threshold period or more.

8. The device of claim 3, wherein the processor is configured to predict a control right transition demand occurrence point by analyzing occurrence history information of the control right transition demand event and the travel environment information.

9. The device of claim 8, wherein, when the vehicle approaches the control right transition demand occurrence point, the processor is configured to activate a control right transition ready mode and output an advance notification.

10. The device of claim 9, wherein the processor is configured to perform control right transition in response to a user response to the advance notification.

11. A method for controlling autonomous driving of a vehicle, the method comprising:
initiating, by the vehicle, the autonomous driving;
detecting travel environment information of the vehicle;
predicting a possible event by utilizing at least one of event data recorded in a data storage system for automated driving (DSSAD) of the vehicle or the travel environment information; and
performing an operation support service for the possible event.

12. The method of claim 11, wherein the event data includes information on an occurrence time and occurrence position information of a predefined event.

13. The method of claim 12, wherein the predefined event includes an autonomous driving function activation event, an autonomous driving function deactivation event, and a control right transition demand event.

14. The method of claim 13, wherein the predicting the possible event includes:
recognizing an autonomous driving function activation frequent section or an autonomous driving function deactivation frequent section by utilizing accumulated data on the autonomous driving function activation event and the autonomous driving function deactivation event; and
sensing whether the vehicle has entered the autonomous driving function activation frequent section or the autonomous driving function deactivation frequent section based on position information of the vehicle.

15. The method of claim 14, wherein the performing the operation support service includes outputting an advance notification for the entry of the autonomous driving function activation frequent section or the autonomous driving function deactivation frequent section.

16. The method of claim 15, wherein the performing the operation support service further includes registering the autonomous driving function activation frequent section or the autonomous driving function deactivation frequent section as user-customized information based on a user response to the advance notification.

17. The method of claim 16, wherein the performing the operation support service further includes deleting the user-customized information when a non-use period of the user-customized information is a threshold period or more.

18. The method of claim 13, wherein the predicting the possible event includes predicting a control right transition demand occurrence point by analyzing occurrence history information of the control right transition demand event and the travel environment information.

19. The method of claim 18, wherein the performing the operation support service includes, when the vehicle approaches the control right transition demand occurrence point, activating a control right transition ready mode and outputting an advance notification.

20. The method of claim 19, wherein the performing the operation support service further includes performing control right transition in response to a user response to the advance notification.
